(19) United States
(12) Patent Application Publication
(10) Pub. No.: US 2025/0312729 A1
(43) Pub. Date: Oct. 9, 2025

(54) CARBON CAPTURE USING SODIUM HYDROXIDE

(71) Applicant: AGC CARBON INC., Madison, CT (US)

(72) Inventor: Sumeet Gandhi, Madison, CT (US)

(73) Assignee: AGC CARBON INC., Madison, CT (US)

(21) Appl. No.: 19/174,860

(22) Filed: Apr. 9, 2025

Related U.S. Application Data
(60) Provisional application No. 63/631,619, filed on Apr. 9, 2024.
(60) Provisional application No. 63/690,557, filed on Sep. 4, 2024.

(51) Int. Cl. B01D 53/14; B01D 53/62; B01D 53/78; C01D 1/04; C01D 7/16; C25B 1/34; H01M 12/06

(52) U.S. Cl. CPC B01D 53/1475; B01D 53/1418; B01D 53/62; B01D 53/78; C01D 1/04; C01D 7/16; C25B 1/34; H01M 12/06; B01D 2251/304; B01D 2251/604; B01D 2257/30; B01D 2257/40; B01D 2257/504; B01D 2258/0283; C01P 2006/80

(57) ABSTRACT

A method for producing soda ash from flue gases involves capturing and processing the gases to remove contaminants and produce a high-purity soda ash. The process involves passing flue gas through a carbon capture system, where nitrates and sulfates are removed from the gas. The gas is then scrubbed with a rich caustic, causing a chemical reaction that removes carbon dioxide. The resulting product is then separated into a purified Na₂CO₃ product, essentially pure soda ash.

### CROSS-REFERENCE TO RELATED APPLICATIONS

This application is also related to U.S. Non-Provisional patent application Ser. No. 19/174,832, Attorney Docket No. 126484-840686, filed on Apr. 9, 2025, entitled “Improved Metal Air Batteries”; U.S. Non-Provisional patent application Ser. No. ______, Attorney Docket No. 126484-840741, filed on Apr. 9, 2025, entitled “LOW TEMPERATURE TRICHLOROSILANE HYDROGENATION”, which claims the benefit of priority to U.S. provisional application No. 63/631,619, filed on Apr. 9, 2024, entitled “ELECTROSYNTHESIS OF TRICHLOROSILANE (USED INTERCHANGEABLY AS TCS OR SIHCL3) USING LOW TEMPERATURE HYDROGENATION OF SILICON TETRACHLORIDE (USED INTERCHANGEABLY AS STC OR SICL4) IN AN ELECTROLYTIC CELL REACTOR WITH CATALYST IMPREGNATED GAS DIFFUSION MEMBRANE AND WITH IR/UV LIGHT ENHANCEMENT” and U.S. provisional application No. 63/690,557, filed on Sep. 4, 2024, entitled “CARBON CAPTURE SYSTEM FOR PRODUCTION OF SODA ASH, BAKING SODA, METHANOL, & FORMALDEHYDE”. All of which are expressly incorporated by reference herein in their entireties.

### BACKGROUND

Many industrial operations produce byproducts that are found harmful to the environment. One byproduct from industrial applications that has been particularly important to remove from the environment is CO₂, a common off gas from industrial operations such as power plants, cement factories, and steel manufacturing facilities. These industries produce substantial amounts of CO₂ as a byproduct of combustion and chemical processes. One method for removing CO₂ is a carbon capture (CC) process where the carbon dioxide is separated and stored.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced. Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings, and the claims

FIG. 1 illustrates an example of a carbon capture system in accordance with some aspects of the subject matter of the present technology.

FIGS. 2A and 2B illustrate an example of a carbon capture system that includes a power generation system in accordance with some aspects of the subject matter of the present technology.

FIGS. 3A, 3B and 3C illustrate an example of a carbon capture system that creates sodium carbonate in accordance with some aspects of the subject matter of the present technology.

FIG. 4 illustrates a routine 400 in accordance with one embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Carbon capture technologies typically capture CO₂ from fuel combustion and other industrial sources to be either pumped into the ground or converted into products that eventually release the CO₂ back to the environment. Different methods of carbon capture have been tried. For example, some carbon capture methods include amine-based systems, absorbent-based systems, oxygen fuel combustion, and solid oxide fuel cells. However, these previous methods can actually lead to increasing the carbon footprint of the plants where they are installed because they rely on the use of carbon-based power systems, e.g., burning coal for electricity. These systems are not only carbon intensive but also have capital expenditures and increase the operational costs of the plant because they have a significant physical footprint that occupies a large portion of the plant or adjacent to the plant and require significant investment in utility upgrades to run the carbon capture systems. Further, these previous systems can produce substantial wastewater and other side products, e.g., nitrous oxide, that have increased disposal and treatment costs. An alternate carbon capture system is needed that will reduce a system's carbon footprint, not require significant storage additions to the process, and provide the energy source to power and operate the CC system.

The improved carbon capture (CC) system described below is a standalone, compact design that minimizes overall system footprint, thereby facilitating easier integration with existing infrastructure. This compatibility enhancement allows for minimal additional investment during installation, reducing upfront costs and increasing the system's economic viability. The CC system's ability to convert CO₂ into a valuable commodity is a significant advantage. Using a caustic-based system, which can also serve as a viable electrolyte, offers a cost-effective solution. Byproducts of this process, such as sodium hydroxide and hydrochloric acid, can be produced, providing additional revenue streams and reducing waste while improving environmental impacts from the carbon capture process.

Regarding CO₂ disposal, the improved CC system provides a reliable and environmentally friendly method of sequestering CO₂. The system's ability to convert CO₂ into a valuable commodity further reduces the environmental impact of CO₂ disposal, making it a more attractive option for industries seeking to mitigate their carbon footprint. The caustic-based system's use of an electrolyte also opens up opportunities for the development of new, sustainable energy storage technologies. By harnessing the properties of caustic solutions, researchers and engineers can uncover innovative ways to improve the efficiency and cost-effectiveness of energy storage systems, such as batteries and supercapacitors.

One example of an improvement using the present system is that the caustic from the CC system can be used as an electrolyte for metal air batteries thereby, creating a system where carbon capture happens in tandem with energy storage or power production from metal-air batteries. Metal air batteries can be adversely impacted due to the absorption of CO₂ from the air. In essence, the improved system can use the CO₂ free air from the improved CC system and clean caustic from metal air batteries to feed the CC system, to combine the treatment and removal of the CO₂ from the improved system. This improved system allows for the replenishment of the caustic for the CC system and the caustic from the metal air batteries to occur in a common reactor. The advantage of such an approach is that it maintains the performance of metal air batteries and leads to higher throughput and charge/discharge cycles of the metal air batteries while also removing the carbon from the underlying improved system.

The use of a metal air battery has never been integrated with CC systems before. However, as will be explained in detail below, advances in metal-air batteries have made it possible to integrate them with renewable energy sources and/or power grids to use them as fuel cells or rechargeable energy storage devices for an improved CC system. Thus, the integration of metal air batteries with the CC system is also possible and yields a dual purpose, whereby the metal air battery acts as a fuel cell, and where the electrolyte for the metal air battery is treated within the CC system to remove the CO₂ captured by electrolyte of the metal air battery.

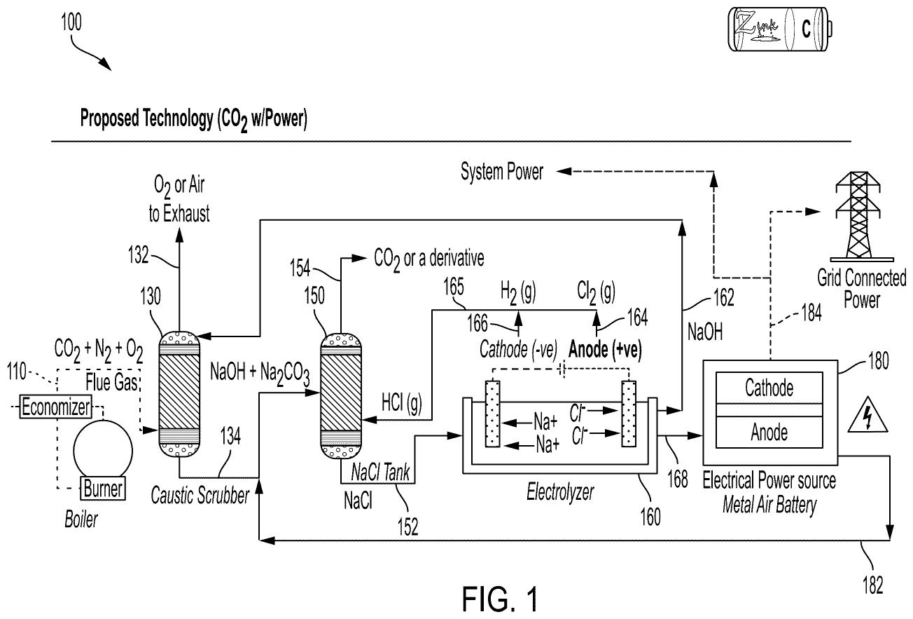

Integrating metal air batteries with a CC system allows for the lowest cost of carbon capture while allowing the improved CC systems to stand alone, without the need for external electrical input or upgrades at the customer's facility. Accordingly, the system includes an improved carbon capture system with an energy storage system. FIG. 1 illustrates an exemplary carbon capture system 100 design consistent with the present disclosure. The carbon capture system 100 is provided as an example to aid in describing the present technology. Although a particular arrangement of components is depicted in FIG. 1, the arrangement of such components should not be considered limiting of the present technology unless otherwise specified in the appended claims.

FIG. 1 illustrates a general system for the implementation of a carbon capture system 100. The carbon capture system 100 can include at least a caustic scrubber, which brings acidic gases from an industrial process, for example, into contact with a caustic solution, e.g., NaOH or KOH. The acidic gases then react chemically with the caustic solution and are absorbed into the solution, removing the gases from the stream that comes into the caustic scrubber. The remaining gases that do not react with the caustic solution leave out of the top of the caustic scrubber, while the caustic solution, after the reaction, can be removed from the bottom of the scrubber.

The carbon capture system 100 can also include a neutralization scrubber 150. The neutralization scrubber 150, which brings the acidic gas, e.g., HCl, into contact with an alkaline scrubbing solution, e.g., NaOH and Na₂CO₃, removes the HCl gas from the scrubber. In one example, the HCl comes into contact with the NaOH and Na₂CO₃, which causes a chemical reaction that releases CO₂ from the alkaline scrubbing solution and creates a salt, NaCl.

Carbon capture system 100 can also include an electrolyzer 160. The electrolyzer 160 can have electrodes (e.g., nickel-based compositions) in contact with an electrolyte to create electricity to drive chemical reactions by electrolysis. By creating a voltage difference between the electrodes, ion migration takes place, and this can drive reduction and oxidation reactions at the electrodes. An electrolyzer can be useful in creating hydrogen gas that allows for the storage of electricity via chemical processes. Depending on the electrolyte, various reactions can take place; for example, if a brine or salt water-based solution is in the electrolyte, one possible reaction product is NaOH.

Carbon capture system 100 can also include an energy storage unit 180, which can be a metal-air battery. The metal air battery can include gas inlets that allow air into the system. When the energy storage unit is a metal-air battery, it can also include an electrolyte to carry the charge created during operation. The electrolyte carries the charge from the anode to the cathode. The air can operate as the cathode for the metal air battery 180 of FIG. 1. The metal air battery can include a current collector, a gas diffusion layer, and a passivating layer. The electrolyte is in contact with the electrodes and facilitates the chemical reaction, driving electrical generation.

In operation, flue gasses from an industrial source can be fed into the carbon capture system 100 as flue gas stream 110. The flue gases or off gases in flue gas stream 110 include CO₂ and other impurities can, and it can initially, be cooled via an interchanger or heat exchanger. The flue gasses can be cooled to between 10 C and 70 C. If further cooling is needed, the intake process can include a secondary cooler such as cooling water exchanger or a glycol cooler. After cooling, the flue gasses can be filtered by, for example, a coalescing filter to remove any oil from the flue gasses. Finally, the flue gases can be fed into a particulate filter, which can be used to remove fine solids in the stream. The removal of fine solids is required to mitigate the risks of hydrogen peroxide dissociation in the subsequent hydrogen peroxide scrubber for SOx and NOx removal. Notably, the dissociation of hydrogen peroxide due to fly ash or fine particulate matter could lead to a potential hydrogen explosion.

The heat that is removed from the input stream using the interchanger and the secondary cooler, can be reused within the system to heat other streams within the carbon capture process. For example, sometimes the caustic used in the process will need an elevated temperature and/or caustic that needs regeneration will need to be heated. By recycling the heat from the flue gases fed into system 100, the environmental impact of the system will be reduced and the economics of the plant will increase.

The flue gas stream 110 is then fed into the caustic scrubber 130, where the CO₂ from the flue gas stream 110 is removed. In the caustic scrubber 130 the flue gasses, including carbon dioxide, nitrogen and oxygen are contacted with a caustic solution, e.g., sodium hydroxide, potassium hydroxide, or calcium hydroxide, and the CO₂ from the flue gas stream 110 is removed via a reaction with the caustic solution. In the caustic scrubber 130, when the flue gas stream 110 comes into contact with the caustic solution, a reaction occurs between the caustic solution and the carbon dioxide. The reaction will typically take the following form:

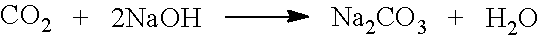

The majority of the carbon dioxide in the flue gasses is captured in the caustic scrubber via the above reaction. The stream that includes NaOH, water, and Na₂CO₃ is diluted and referred to as a lean caustic stream 134 and exits the caustic scrubber 130 through the bottoms product. The distillate is substantially oxygen, nitrogen, and/or carbon monoxide. The distillate can either be further filtered and/or released into the atmosphere.

The lean caustic stream 134 from caustic scrubber 130 can be fed into a neutralization scrubber 150, where the NaOH and Na₂CO₃ is fed into the neutralization scrubber 150 and reacted with hydrochloric acid, to form NaCl and water along with carbon dioxide. The neutralization scrubber 150 is typically operated from about 20 C to slightly elevated temperature of 60 C. The remaining CO₂ that is produced by the neutralization scrubber 150 can be released via CO₂ outlet 154 to the environment or further processed as will be discussed with respect to later implementations of the present disclosure. The NaCl and water is transferred out via the neutralization scrubber bottoms 152 of the neutralization scrubber 150 to an electrolyzer 160 that can create an electrolyte for an energy storage unit 180 along with hydrogen gas and chlorine gas for the creation of the hydrochloric acid used in the neutralization scrubber 150.

The electrolyzer 160 receives the NaCl and water from the neutralization scrubber bottoms 152 and undergoes a chloralkali process to form hydrogen gas, chlorine gas and sodium hydroxide. The electrolyzer 160 passes a current through an aqueous solution that includes the NaCl from the neutralization scrubber 150, and electrolysis separates the ions and produces chlorine gas (Cl₂) 164 through an oxidation reaction at the anode and hydrogen gas (H2) 166 and sodium hydroxide, through a reduction reaction, at the cathode. The electrolyzer 160 can include a membrane (not shown) to separate the products and facilitate the creation of the products, e.g., sodium hydroxide, hydrogen gas, and chlorine gas.

The hydrogen gas 166 and the chlorine gas 164 can be combined to form hydrochloric acid, HCl stream 165, that can be used in the neutralization scrubber 150 to facilitate formation of the carbon dioxide for CO₂ outlet 154 and NaCl for the electrolyzer 160. The sodium hydroxide formed in the electrolyzer 160 can be fed via NaOH stream 162 into the caustic scrubber 130 and used to remove the carbon dioxide from the flue gasses. The NaOH stream 162 can be chlorinated by combining it with the chlorine gas 164 from the electrolyzer 160, to additionally create NaOCl, NaCl, and water as byproducts of the reactions. The chlorination reaction will typically be run at low temperatures, e.g., less than 25 C to prevent the hypochlorite product from decomposing. The NaOH can also be fed into an energy storage unit 180, via stream 168, where the energy storage unit 180 can utilize the NaOH as an electrolyte for power production in a metal air battery, which will be discussed in detail below. The energy storage unit 180 can be used to power the carbon capture system 100, to provide the power to the grid, or both. The NaOH from the energy storage unit 180 can be recycled into lean caustic stream 134 to improve the overall efficiency of carbon capture system 100.

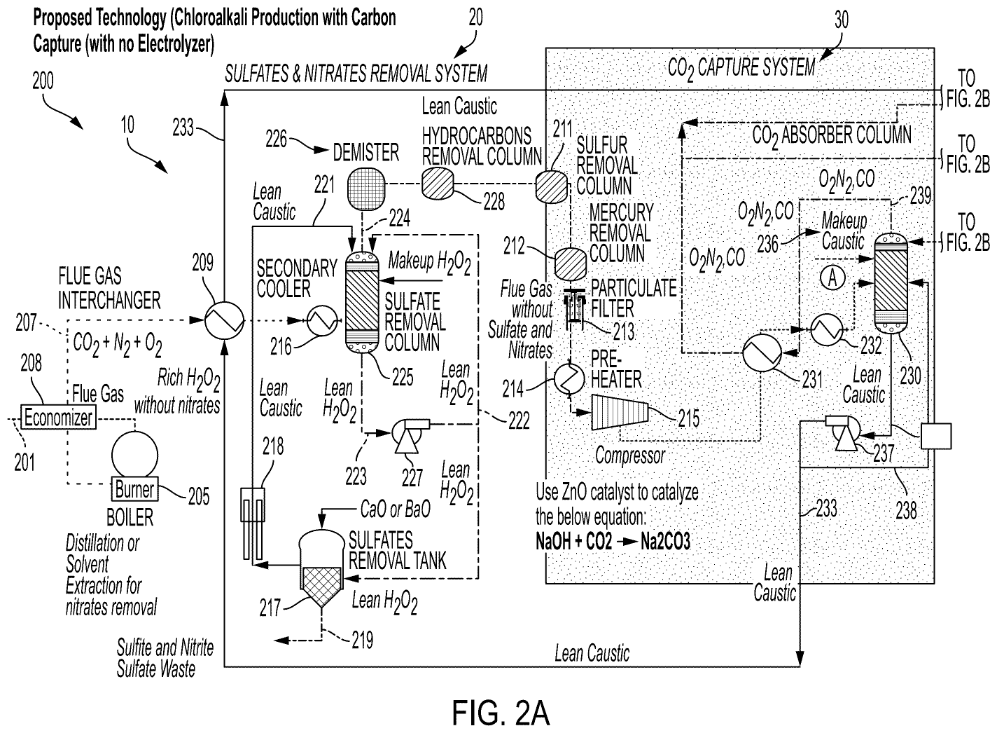

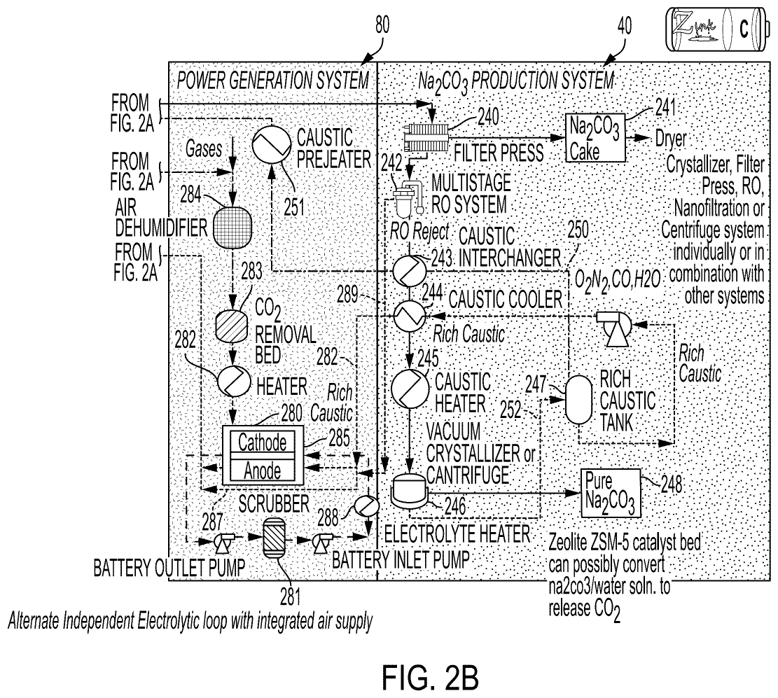

FIGS. 2A and 2B illustrate an exemplary carbon capture system 200 that uses chloroalkali production along with the carbon capture. The carbon capture system 200 includes a sulfate and nitrate removal system 220, a caustic scrubber 230, an energy storage system 280, and a sodium carbonate production system that includes filter press 240. The carbon capture system 200 takes the flue gasses from an industrial process and creates oxygen, nitrogen, carbon monoxide, sodium carbonate, and electricity. The gasses from the carbon capture system 200 meet the national standards for air quality and are able to be released. The sodium carbonate can be sold for use in industrial, commercial, or consumer applications. The carbon capture system 200 takes an environmentally problematic flue gas 201 and converts them to environmentally friendly products in an economic manner.

Carbon capture system 200 can include In addition to the caustic scrubber, that was discussed above with respect to FIG. 1, carbon capture system 200 can also include a hydrogen peroxide scrubber 225. The hydrogen peroxide scrubber 225 of FIG. 2A works through the process of oxidation by the hydrogen peroxide of the compounds in the flue gases. For example, sulfur containing pollutants, e.g., SO₂ or H₂S, can be oxidized to form sulfuric acid and/or sulfate salts, depending on the operating conditions of the hydrogen peroxide scrubber 225. These sulfates can then be precipitated out of solution and removed from the system outside of the hydrogen peroxide scrubber 225. Similarly, the nitrates, which typically form from a combustion process, can be oxidized to form nitric acid and/or nitrate salts, depending on the operating conditions of the hydrogen peroxide scrubber 225. The nitrate salts can be soluble. The nitrates or nitric acid can be neutralized and then separated from solution outside the hydrogen peroxide scrubber 225.

Carbon capture system 200 can also include a demister 226. A demister removes the latent liquid droplets introduced to the stream during, e.g., a scrubbing process. The demister, therefore, can remove additional contaminates that remains as liquid droplets in a stream. Carbon capture system 200 can also include a hydrocarbon removal column 228, which can be, for example, a distillation column, an absorption column, an adsorption column, or similar. The hydrocarbon removal column 228 is capable of removing any remaining hydrocarbons that are present in the input stream. Generally, removal of hydrocarbons using distillation is sufficient to remove any hydrocarbon contaminants left in the stream, due to the differences in boiling point between the contaminants and the desired products, e.g., CO₂, O₂, and N₂. Carbon capture system 200 can also include a sulfur removal column 211. Sulfur removal column 211 can be, for example, an absorber/scrubber that uses reactive absorption of sulfur compounds by for example, a zeolite, polymer resin, or an alkaline solution like limestone or lime. The reaction in the sulfur removal column 211 can remove substantially all of the remaining sulfur contaminants. Carbon capture system 200 can also include a mercury removal column 212. The mercury removal column 212 is typically going to comprise an adsorption column that includes, e.g., impregnated activated carbon, gold and/or silver on supports, or a zeolite tailored for mercury removal. The mercury removal column 212 can remove substantially all mercury that is present in an input stream. Additionally, carbon capture system 200 can include a particulate filter 213 which removes any particulates that may still be present in a stream that are larger than the size of the filter. Because the particulates will be considered quite large compared to the desired products, e.g., O₂, CO₂ and N₂, particulate filtering should remove all particulate that is present in the input stream.

As shown in FIG. 2A, the above-mentioned components can be configured in series, so that the output of the hydrogen peroxide scrubber 225 is transferred to the demister 226, then to the hydrocarbon removal column 228, then the top stream 224 is sent to sulfur removal column 211, followed by the mercury removal column 212, before finally being transferred to the particulate filter 213. However, the exact order of these components in series is not required by the present disclosure. Instead, the components can be in a different order, omitted, or placed in parallel as needed by the system. The carbon capture system 200 uses these series of components to create a purified stream into the caustic scrubber 230, and when used as described herein below, it is possible to achieve a soda ash purity in excess of 95%, and most preferably in excess of 99% pure soda ash.

The components, e.g., hydrogen peroxide scrubber 225, demister 226, hydrocarbon removal column 228, sulfur removal column 211, mercury removal column 212, and particulate filter 213 are depicted as being after the hydrogen peroxide scrubber 225. However, it will be understood that, depending on the components within the flue gasses 201, it can be preferable to put one or more of the components prior to the hydrogen peroxide scrubber 225. This can provide improved performance of the hydrogen peroxide scrubber 225 if the flue gasses are particularly dirty. For example, if the flue gasses contain a significant amount of fly ash, it would be preferable to place the particulate filter 213 prior to the hydrogen peroxide scrubber 225, so that the fly ash does not contaminate the hydrogen peroxide system.

In operation, carbon capture system 200 can receive flue gasses 201 from an economizer 203, which allows for an exchange of heat between the flue gasses 201 and the heated gas in stream 207. The flue gasses 201 enter economizer 203 on the hot side and transfer energy to the heated gasses in stream 207. The economizer 203 and the boiler 205 work together to efficiently heat gases in stream 207. The gasses leave economizer 203 and enter boiler 205, where the gasses are further heated and sent through the cold side of economizer 203, where additional heating takes place. After further heating by economizer 203, the heated gasses in stream 207, which include carbon dioxide, nitrogen, and oxygen, enter flue gas interchanger 209, where the heat from the heated gasses in stream 207 is used to heat the lean caustic stream 233 that is formed later in the process. s

After the flue gas interchanger 209, the cooled gasses are introduced into the sulfate and nitrate removal system, where the substantial majority of any sulfates or nitrates present in the flue gasses 201 are removed prior to the carbon dioxide being removed from the stream. The cooled gases of stream 207 are fed into the hydrogen peroxide scrubber 225, which can remove the sulfates and nitrates present in the flue gas. The gasses are preferably cooled below 50 C, and more preferably cooled to between 10 C and 30 C prior to being introduced to the hydrogen peroxide scrubber 225. If temperatures exceed 50 C, the hydrogen peroxide can dissociate, creating hydrogen gas, which is an explosion hazard. After the chemical scrubbing takes place, the bottoms 223 of the hydrogen peroxide scrubber 225 will contain the substantial majority of all sulfates and nitrates, which can be further purified.

The bottoms 223 from the hydrogen peroxide scrubber 225, which are a lean peroxide solution, are fed to a pump 227 which either recycles the stream back to the hydrogen peroxide scrubber 225 via stream 222 or transfers the bottoms 223 to a sulfate removal tank 217. The sulfate removal tank 217 can take the bottoms 223 and precipitate out the sulfates from the lean hydrogen peroxide solution via the addition of, for example, calcium oxide or barium oxide. The calcium oxide or barium oxide will typically form calcium sulfate or barium sulfate, respectively, each of which is insoluble in solution. Therefore, the calcium sulfate or barium sulfate will be removed via the waste stream 219. The nitrates will typically be removed via a different process, via separation column 218. Separation column 218 can be a distillation column, ion-exchange, electrodialysis, reverse osmosis, or solvent extraction column. The rich hydrogen peroxide stream 221, after the sulfates and nitrates are removed, is recycled back into the hydrogen peroxide scrubber 225, for the removal of sulfates and nitrates within the scrubber. The carbon capture system 200 can also have additional hydrogen peroxide added to the hydrogen peroxide scrubber 225, to make up for any losses during the sulfate and nitrate removal.

Top stream 224 from the hydrogen peroxide scrubber 225 is then transferred to a demister 226, which removes the latent liquid droplets introduced during the scrubbing process from the top stream 224. Once the liquid droplets are removed, the top stream 224 can be further purified by removing any hydrocarbons that may be present in the top stream 224. Hydrocarbon removal can take place via a hydrocarbon removal column 228, which can be, for example, a distillation column, that removes the hydrocarbons from top stream 224. After the hydrocarbon removal column 228, the top stream 224 can be transferred to sulfur removal column 211. The sulfur removal column is, for example, an absorber that uses reactive absorption of sulfur compounds so that there are essentially no sulfur compounds left in the top stream 224 after it exits the sulfur removal column 211. The top stream can be transferred from the sulfur removal column 211 to mercury removal column 212. The mercury removal column 212 is typically going to comprise an adsorption column that includes, e.g., impregnated activated carbon. After removing essentially all of the mercury, the top stream 224 can be transferred to particulate filter 213, which removes any particulates that may still be present in the top stream 224.

Once the top stream 224 has been purified the top stream 224, essentially free from contaminants, needs to be prepared for CO₂ capture in caustic scrubber 230. Initially, the top stream 224 is heated by pre-heater 214 to between 30 C to 70 C, with 32 C being the preferred temperature. Pre-heater 214 can be any known vapor heating method, for example, a direct or indirect heater, which can be electric, gas, steam, etc., that can heat the vapor stream. After being heated by pre-heater 214, the top stream 224 is compressed by compressor 215 to manage deposition of any trace elemental sulfur present in the top stream 224. The compressed top stream 224 is then cooled in a interchanger 231, which can be an interchanger that cools the top stream 224 using the off gasses from caustic scrubber 230. After the interchanger, the top stream 224 is fed into the caustic scrubber 230 where the carbon dioxide is recovered.

The caustic scrubber 230 of FIG. 2A is similar to caustic scrubber 130 of FIG. 1 and operates in a similar manner. The top stream 224 is then fed into the caustic scrubber 230, where the CO₂ from the top stream 224 is removed. In the caustic scrubber 230 the top stream 224, including carbon dioxide, nitrogen and oxygen are contacted with a caustic solution, e.g., sodium hydroxide, potassium hydroxide, or calcium hydroxide, and the CO₂ from the top stream 224 is removed via a reaction with the caustic solution. In the caustic scrubber 230 when the vapors come into contact with the caustic solution a reaction occurs between the caustic solution and the carbon dioxide. The reaction will typically take the following form:

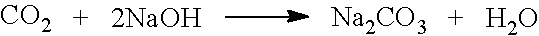

The majority of the carbon dioxide in the vapors that enter the caustic scrubber 230 is captured in the caustic solution via the above reaction. The resulting stream includes NaOH, water, and Na₂CO₃ and is, therefore, diluted and referred to as a lean caustic stream 234. Lean caustic stream 234 exits the caustic scrubber 230 through the bottoms product.

The lean caustic stream 234 from caustic scrubber 230 can be pumped, via pump 237, from the bottoms of the caustic scrubber 230 to an Na₂CO₃ production system. The lean caustic stream 234 can be split into multiple streams, e.g., lean caustic stream 233 and recycle stream 238, as shown in FIG. 2A. Lean caustic stream 233 can be used to heat the gases in stream 207 via flue gas interchanger 209. Stream 233 would then continue to Na₂CO₃ production system for further processing. Recycle stream 238 is recycled back into the caustic scrubber 230 to provide the caustic used in the caustic scrubber 230. In one embodiment, it is preferable to control the flow rate of recycle stream 238 so that the lean caustic stream 233 maintains a concentration of Na₂CO₃ in the stream of between 4 and 6%. To achieve a concentration of 4% to 6%, it can also be preferable to control the flow rate of top stream 224 and the rate of rich caustic stream into the caustic scrubber 230. The three inputs can work together to maintain the desired concentration, e.g., 4% to 6%. If additional rich caustic is needed, it can be added to caustic scrubber 230 through a make-up caustic 236, thereby maintaining the level of caustic needed to complete the removal of CO₂ sure there is sufficient caustic in the scrubber to complete the removal of the CO₂. The caustic scrubber 230 can preferably recover greater than 85% of the CO₂ from stream top stream 224, and more preferably recover up to 95% of the CO₂ from stream top stream 224.

The top stream 239, which includes primarily oxygen, nitrogen, and carbon dioxide, is then fed into interchanger 231, which cools off the gasses coming from compressor 215. After the interchanger 231, the top stream 239 can either be further filtered and/or released into the atmosphere. The top stream 239 meets the standards set forth for atmospheric release, specifically complying with the National Ambient Air Quality Standards (NAAQs) for particulate matter known as PM2.5, as well as standards for carbon monoxide, sulfur dioxide, nitrogen dioxide, and lead. Through the purification process described above, a system that conforms to the present disclosure will help an industrial plant meet its NAAQ obligations. The top stream 239, meeting the NAAQ standards, can therefore, be released is an environmentally acceptable manner for disposing of the top stream 239. Alternatively, the gasses in top stream 239 can be sent to a power generation system for use in powering the carbon capture system 200.

The lean caustic in Lean caustic stream 233 can be transferred to a Na₂CO₃ production system of FIG. 2B where a substantially pure Na₂CO₃ can be generated. Initially, the lean caustic stream 233 can be heated with a preheater 251 to increase the temperature of the lean caustic stream 233 prior to separating the sodium hydroxide from the sodium carbonate. After a temperature adjustment, if needed, the lean caustic stream 233 is fed to a plate and frame filter press 240 or similar membrane filters to remove Total Suspended Solids (TSS), and the wet cake from the filter press 240 is recovered as sodium carbonate. The wet sodium carbonate cake is further dried using a dryer 241 to remove residual moisture and provide essentially substantially pure Na₂CO₃. Furthermore, in addition to or in place of the dryer 241, the system can use one or a combination of systems such as crystallizer, rotary filter, filter press, reverse osmosis, nanofiltration, centrifuge, or any other system to separate and/or purify Na₂CO₃.

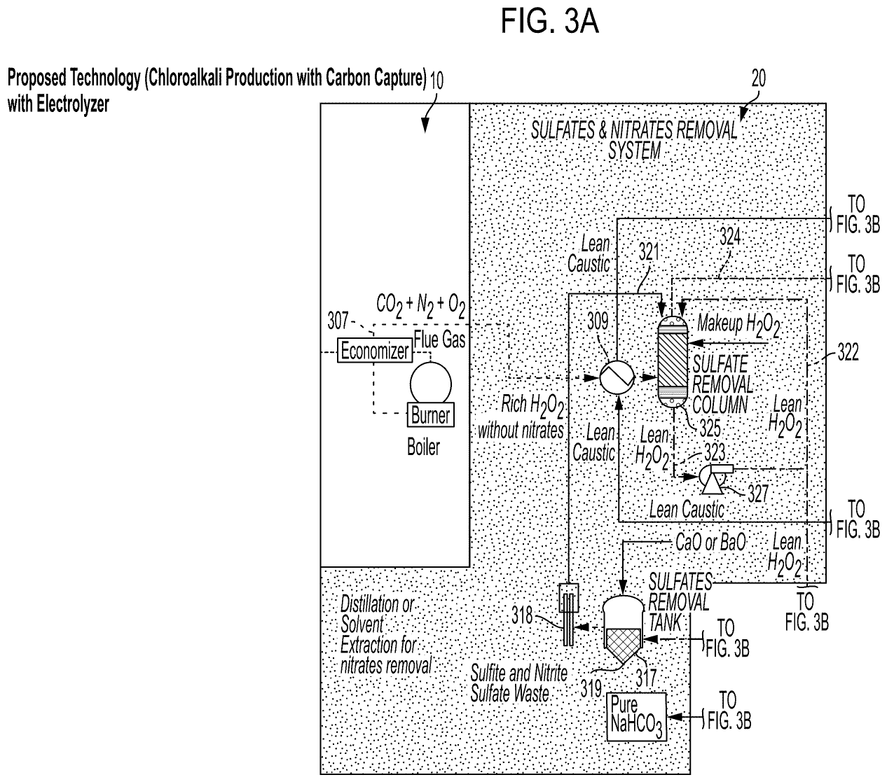

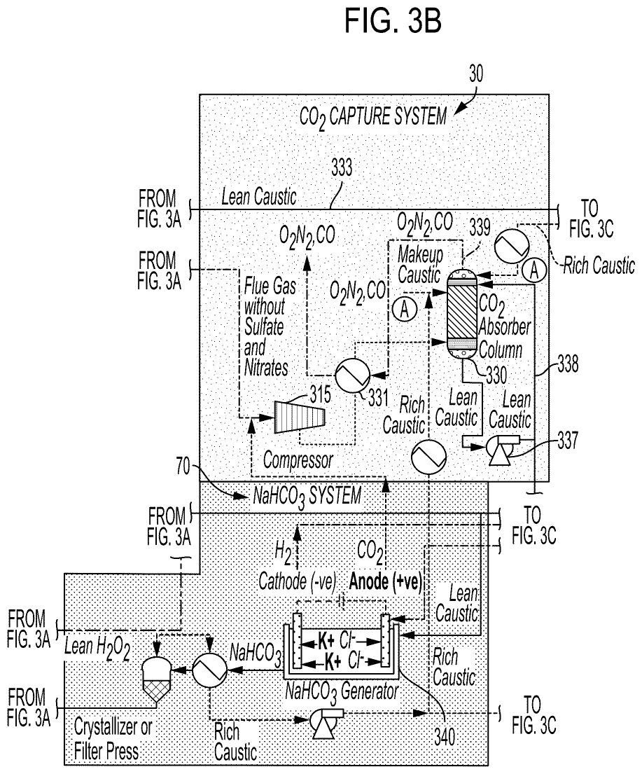

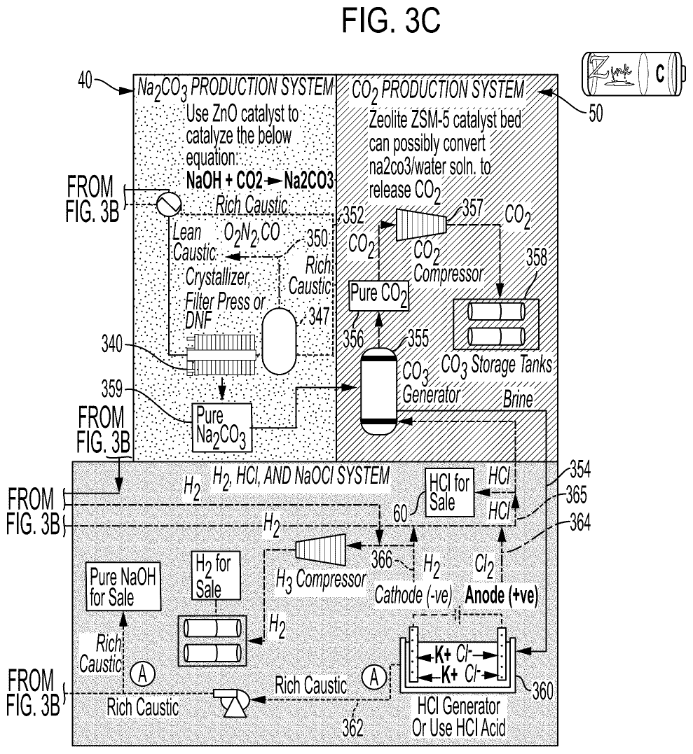

In one example, the substantially pure Na2CO3 from lean caustic stream 233 can be in excess of 99% pure Na2CO3. In this example, the Na2CO3 is able to achieve 99% purity based on the purifying steps taking place at each step of the in FIG. 2A-2B and FIG. 3A-3C. For example, when the flue gas enters the system, it is purified with the

The lean caustic stream 233 after the removal of the substantial majority of the Na₂CO₃ present in the stream using the filter press or similar method, can be further purified using a multi-stage reverse osmosis (RO) 242 of FIG. 2B, nanofiltration, dissolved air filtration, and deionization beds individually or in combination to remove most of the Total Dissolved Solids (TDS) present in the lean caustic stream 233 after the filter press 240, the TDS consist mainly of Na₂CO₃. The purified stream 249 from the RO 242 is sufficiently pure to be considered a rich caustic stream and can be used in the power generation system as an electrolyte and purified stream 249 of FIG. 2B can also be used as the make-up caustic 236 of FIG. 2A and/or the primary caustic used in the caustic scrubber 230 of FIG. 2A to capture CO₂ from flue gas. The lean caustic stream 233 from the RO reject or other TDS separation systems is fed to a caustic interchanger 243 of FIG. 2B to provide heat to the feed stream of the crystallizer 246 and/or a centrifuge by recovering vapor and liquid phase heat from the outlet stream of the crystallizer 246 and/or a centrifuge. The lean caustic stream 233 is further heated using, e.g., an electric heater 245, to further preheat the lean caustic stream 233 before it is fed into the crystallizer 246 and/or a centrifuge. The crystallizer 246 and/or a centrifuge is used to remove any residual Na₂CO₃ present in the lean caustic stream 233.

The caustic stream discharged from the crystallizer of FIG. 2B or centrifuge, like the purified stream 249, is sufficiently pure to turn the lean caustic stream 233 into a rich caustic stream 252. The rich caustic stream 252 of FIG. 2B can be stored in rich caustic tank 247. Any oxygen, nitrogen, carbon monoxide, or water can be removed from rich caustic tank 247, and, like the top stream 239, the gases removed from rich caustic tank 247 are sufficiently clean to meet all environmental regulations related to the NAAQ standards and can be released into the atmosphere or stored for later disposal. Rich caustic stream 252 of FIG. 2B can be used wholly or partially in the power generation system as an electrolyte and rich caustic stream 252 can also be used as the make-up caustic 236 and/or the primary caustic used in the caustic scrubber 230 to capture CO₂ from flue gases. Furthermore, the purified stream 249 can be combined with rich caustic stream 252 and used for the energy storage system 280 and the caustic scrubber 230.

The cooled outlet rich caustic stream from the caustic interchanger 243 of FIG. 2B is further cooled using a refrigerant or a cooling water heat exchanger 244 before feeding the rich caustic stream 252 either to the energy storage system 280 of FIG. 2B or the caustic scrubber 230 of FIG. 2A.

The rich caustic stream 252, which is rich in NaOH, can be fed into an energy storage system 280 of FIG. 2B, via rich caustic stream 252, optionally mixed with purified stream 249. Energy storage system 280 can utilize the NaOH as an electrolyte for power production in a metal air battery, which will be discussed in detail below. The energy storage system 280 can be used to power the carbon capture system 200, to provide the power to the grid, or both. The NaOH from the energy storage system 280 can be recycled into caustic scrubber 230 to improve the overall efficiency of carbon capture system 200.

Rich caustic stream 252, optionally mixed with purified stream 249, can be used as the electrolyte in the energy storage system 280 of FIG. 2B, in this example, the electrical power source is a Metal-Air Battery (MAB) 285. The MAB 285 is consistent with the metal air battery of U.S. patent application Ser. No. 19/174,832 assigned to the same owners and hereby incorporated by reference in its entirety. The MAB 285 can be a zinc air battery, lithium air battery, or aluminum air battery or it may alternatively be a Mixed Metal Air Battery (MMAB), a version of MAB in which the anode consists of one or more combination of metals such as lithium and zinc or zinc and sodium to name a few. The use of MAB 285 allows for the use of the caustic streams from other systems within the carbon capture system 200 to provide power to the system. For example, the rich caustic stream 252 of FIG. 2B can be used as the electrolyte for the MAB 285. Further, it is possible for the MAB to have its own rich caustic loop 287, that includes a feed pump, a CO₂ scrubber 281, a discharge pump, and an electrolyte heater 288 to maintain the feed temperature of the rich caustic loop 287 of FIG. 2B. Because the operation of the MAB 285 can be impacted by the presence of CO₂, CO₂ scrubber 283 is included in the loop to remove CO₂ from the air prior to its use in MAB 285. By creating a loop that can use the caustic ingredients of the carbon capture system 200, an MAB can be placed at any location throughout the carbon capture system 200 that has caustic that can be used as an electrolyte in the MAB.

The MAB 285 can be a fuel cell, an energy storage device, or a power supply to power the carbon capture system 200. Further, the MAB 285 can also be connected to the electrical grid and used to supply power outside of the carbon capture system 200, including to residential customers, and/or downstream commercial customers. Alternatively, it is possible to recharge the battery via the electrical grid, if needed.

The MAB 285 can be regenerated either through grid power, renewable energy sources, for example, wind or solar, electrochemical processes, and/or other sources considered to be green energy sources with byproducts generated from carbon capture system 200. Choosing to regenerate MAB 285 of FIG. 2B with green energy sources can reduce the overall environmental impact of the carbon capture system 200.

The air for the MAB 285 can be supplied from the output of caustic scrubber 230 of FIG. 2A, because top stream 239 includes primarily oxygen, nitrogen, and carbon monoxide. The top stream 239 can be treated first by a dehumidifier 284, to remove any excess moisture from top stream 239. Top stream 239 is then transferred to CO₂ scrubber 283 for removing any remaining CO₂ from top stream 239. CO₂ scrubber 283 can also be an adsorbent bed in addition to a scrubber. The mist from the air for the MAB 285 can be removed via a desmister bed. Further, the temperature of the air and electrolyte for the MAB 285 can be controlled using heaters, and the temperatures are generally within the range of −10 C to 60 C, depending on the electrolyte chosen as well as the metal chosen for the battery. It is preferable that the MAB 285 be designed to operate at ambient temperatures.

The MAB 285 can be used to charge the battery from an external source, discharge the battery to an external source, or be used as a rechargeable battery source while providing power to external sources. The MAB 285 can be charged and used simultaneously.

FIGS. 3A-3C represent another exemplary embodiment of the present disclosure. FIGS. 3A-3C have many of the same systems as those discussed above with respect to FIGS. 2A-2B, and the same components use similar numbers to reflect that they operate in the same way as previously discussed. However, while FIGS. 2A-2B represents a carbon capture system 200 that has a power generation system, it is also possible to implement the present disclosure with additional components that can replace or be in addition to the power generation system in FIGS. 2A-2B. Exemplary Carbon capture system 300 illustrates that the Carbon capture system 300 can also include hydrochloric acid production, sodium bicarbonate production, and further carbon dioxide purification.

Carbon capture system 300 can include additional components in addition to the caustic scrubber 230 and hydrogen peroxide scrubber 225, which were described above with respect to FIGS. 2A-2B. Carbon capture system 300 can also include an NaHCO₃ generator 370, which utilizes an electrolysis process, that will normally include a anode, cathode and membrane to facilitate the production of the components of NaHCO₃, including sodium hydroxide from a brine solution which can be combined with carbon dioxide to in a process to make NaHCO₃. The other products include hydrogen gas and chlorine gas along with a caustic stream.

The carbon capture system 300 can also include a neutralization scrubber 355. Neutralization scrubber 355 can be a stirred tank reactor or similar that allows for the mixing of the inputs, e.g., Na₂CO₃ and HCl, to create carbon dioxide and a brine solution. Neutralization scrubber 355 is similar to neutralization scrubber 150 and operates in a similar fashion. The neutralization scrubber 355 is typically operated from about 20 C to a slightly elevated temperature of 60 C.

Carbon capture system 300 can also include electrolyzer 360, which is similar to electrolyzer 160 and is capable of creating hydrogen gas and chlorine gas using an electrolysis mechanism. Electrolyzer 360 of FIG. 3C can have electrodes, e.g., nickel-based compositions, in contact with an electrolyte to create electricity to drive chemical reactions by electrolysis. By creating a voltage difference between the electrodes, ion migration takes place, and this can drive reduction and oxidation reactions at the electrodes. Electrolyzers can be useful in creating hydrogen gas that allows for the storage of electricity via chemical processes. Depending on the electrolyte, various reactions can take place; for example, if a brine or salt water-based solution is in the electrolyte, one possible reaction product is NaOH. The electrolyzer 360 can include a membrane (not shown) to separate the products and facilitate the creation of the products, e.g., sodium hydroxide, hydrogen gas, and chlorine gas.

Carbon capture system 300 can also include the purifying components described with respect to FIG. 2A. The components, e.g., hydrogen peroxide scrubber 225, demister 226, hydrocarbon removal column 228, sulfur removal column 211, mercury removal column 212, and particulate filter 213 are depicted and can be either before or after the hydrogen peroxide scrubber 225. Correspondingly, these components can be before or after hydrogen peroxide scrubber 325. Similarly, it will be understood that, depending on the components within the flue gasses 301, it may be preferable to put one or more of the components prior to the hydrogen peroxide scrubber 325.

In operation, carbon capture system 300 can have flue gasses 301 enter through an economizer 303, which allows for exchange of heat between the flue gasses 301 and the heated gas stream 307. The flue gasses 301 enter the economizer 303 on the hot side and transfer energy to the heated gasses in stream 307. The economizer 303 and the boiler 305 work together to efficiently create a heated gas stream 307. The gasses leave the economizer 303 and enter the boiler 305, where the gasses are further heated and sent through the cold side of economizer 303, where additional heating takes place. After the further heating by the economizer 303, the heated gasses 307, which include carbon dioxide, nitrogen, and oxygen, enter flue gas interchanger 309, where the heat from the heated gasses 307 is used to heat the lean caustic stream 333 that is formed later in the process.

After the flue gas interchanger 309, the heated gasses are introduced into the sulfate and nitrate removal system, where the substantial majority of any sulfates or nitrates present in the flue gasses are removed prior to the carbon dioxide being removed from the stream. The heated gas stream 307 is fed into the hydrogen peroxide scrubber 325, which is used to remove the sulfates and nitrates present in the flue gas. The hydrogen peroxide scrubber 325 works as previously described with respect to hydrogen peroxide scrubber 225 in FIG. 2A.

The bottoms 323 of FIG. 3A from the hydrogen peroxide scrubber 325, which are a lean peroxide solution, are fed to a pump 327 which sends the solution either back to the hydrogen peroxide scrubber 325 via stream 322 or to a sulfate removal tank 317. The top stream 324 FIG. 3A from the hydrogen peroxide scrubber 325 can be further purified, if necessary, first by a demister 326, which removes the latent liquid droplets introduced during the scrubbing process from the top stream 324. Once the liquid droplets are removed, the top stream 324 can be further purified by removing any hydrocarbons that may be present in the top stream 324. Hydrocarbon removal can take place via a hydrocarbon removal column 328, which can be, for example, a distillation column, an absorption column, an adsorption column, or similar. If the top stream 324 contains any sulfur compounds, they can be removed in sulfur removal column 311. The sulfur removal column is, for example, an absorber/scrubber that uses reactive absorption of sulfur compounds using an alkaline solution like limestone or lime. If the top stream 324 includes any mercury, then the top stream 324 can be transferred to a mercury removal column 312. The mercury removal column 312 is typically going to comprise an adsorption column that includes, e.g., impregnated activated carbon, gold and/or silver on supports, or a zeolite tailored for mercury removal. The top stream 324 will be passed over the adsorption materials to remove any mercury present. Finally, the top stream 324 can be transferred to a particulate filter 313, which removes any particulates that may still be present in the top stream 324.

Once the top stream 224 has been purified as stated above, the top stream 324 needs to be prepared for CO₂ capture. Initially, the top stream 324 is heated by pre-heater 214 to between 30 C to 70 C, with 50 C being the preferred temperature. Pre-heater 214 can be any known vapor heating method, for example, a direct or indirect heater, which can be electric, gas, steam, etc., that can heat the vapor stream. After being heated by pre-heater 314, the top stream 324 is compressed by compressor 215 to manage deposition of any trace elemental sulfur present in the top stream 324. The compressed top stream 324 is then cooled in interchanger 331, which can be an interchanger that cools the top stream 324 using the off gasses from caustic scrubber 330. After the interchanger, the top stream 324 is fed into the caustic scrubber 330 where the carbon dioxide is recovered.

The caustic scrubber 330 is similar to caustic scrubber 130 from FIG. 1 and caustic scrubber 230 from FIG. 2A and operates in a similar manner. The top stream 324 is then fed into the caustic scrubber 330, where the CO₂ from the top stream 324 is removed. In the caustic scrubber 330 the top stream 324, including carbon dioxide, nitrogen and oxygen are contacted with a caustic solution, e.g., sodium hydroxide, potassium hydroxide, or calcium hydroxide, and the CO₂ from the top stream 324 is removed via a reaction with the caustic solution. In the caustic scrubber 330 when the vapors come into contact with the caustic solution a reaction occurs between the caustic solution and the carbon dioxide. The reaction will typically take the following form:

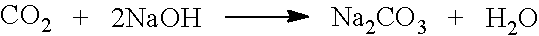

The reaction can be catalyzed by a Zeolite ZSM-5 catalyst or similar. The majority of the carbon dioxide in the vapors that enter the caustic scrubber 330 is captured in the caustic solution via the above reaction. The resulting stream includes NaOH, water, and Na₂CO₃ and is, therefore, diluted and referred to as a lean caustic stream 333. Lean caustic stream 333 exits the caustic scrubber 330 through the bottoms product. The distillate in top stream 339 is substantially oxygen, nitrogen, and/or carbon monoxide. The top stream 339 can either be further filtered and/or released into the atmosphere.

The lean caustic stream 333 from caustic scrubber 330 can be pumped, via pump 337, from the bottoms of the caustic scrubber 330 to an Na₂CO₃ production system. The lean caustic stream 333 can be split into multiple streams, e.g., lean caustic stream 333 and recycle stream 338, as shown in FIG. 3B. Lean caustic stream 333 can be used to heat the gases in stream 207 via flue gas interchanger 309. Lean caustic stream 333 would then continue to Na₂CO₃ production system for further processing. Stream 338 is recycled back into the caustic scrubber 330 to provide the caustic used in the caustic scrubber 330. Additional caustic can be added to caustic scrubber 330 through a make-up caustic line 336, thereby making sure there is sufficient caustic in the scrubber to complete the removal of the CO₂. The caustic scrubber 330 recovers greater than 99% of the CO₂ from stream top stream 324.

The top stream 339, which includes primarily oxygen, nitrogen, and carbon dioxide, is then fed into interchanger 331, which cools off the gasses coming from compressor 315. After the interchanger 331, the top stream 339 can be released to the atmosphere, as it is clean enough to meet the environmental standards for release and/or it can be sent to a power generation system for use in powering the Carbon capture system 300.

The caustic scrubber 330 of FIG. 3B can operate a catalytic reaction to adsorb the CO₂. The catalyst is often a Zeolite ZSM-5 catalyst or similar that can be used to facilitate the reaction of sodium hydroxide with CO₂. Additional catalysts that can be considered for use are transition metal catalysts, such as nickel carbonic anhydrase. Catalysts can lose efficacy over time via fouling or other mechanisms and need to be regenerated to achieve optimal functionality. For the Carbon capture system 300, and other embodiments described herein, one way to achieve regeneration is to pass 6M NaOH through the caustic scrubber 330, which will release any adsorbed CO₂ as Na₂CO₃. Regeneration allows the catalyst to continue to capture substantially all of the CO₂ in the system.

In a further example of the present disclosure, the lean caustic stream 333 can be transferred to a Na₂CO₃ production system where a substantially pure Na₂CO₃ can be created. Initially, the lean caustic stream 333 can be heated with a preheater 351 to increase the temperature of the lean caustic stream 333 prior to separating the sodium hydroxide from the sodium carbonate. After a temperature adjustment, if needed, the lean caustic stream 333 is fed to a plate and frame filter press 340 of FIG. 3C or similar membrane filters to remove Total Suspended Solids (TSS), and the wet cake from the filter press 340 is recovered as sodium carbonate. The wet sodium carbonate cake is further dried using a dryer 341 to remove residual moisture and provide essentially substantially pure Na₂CO₃. Furthermore, in addition to or in place of the dryer 341, the system can use a crystallizer, filter press, reverse osmosis, nanofiltration, centrifuge, or any other system to separate and/or purify Na₂CO₃.

The lean caustic stream 333 after the removal of the substantial majority of the Na₂CO₃ present in the stream using the filter press 340 or similar method, can be further purified, as previously described. The caustic stream discharged from the filter press, and potential further purification, is sufficiently pure to turn the lean caustic stream 333 into a rich caustic stream 352 of FIG. 3C. The rich caustic stream 352 can be stored in rich caustic tank 347. Any oxygen, nitrogen, carbon monoxide, or water can be removed from rich caustic tank 347, and, like the top stream 339, the gases removed from rich caustic tank 347 are sufficiently clean to meet all environmental regulations to be released. Rich caustic stream 352 can be used wholly or partially in the power generation system as an electrolyte, and rich caustic stream 352 can also be used as the makeup caustic line 336 and/or the primary caustic used in the caustic scrubber 330 to capture CO₂ from flue gases.

The substantially pure Na₂CO₃ 359 can be further processed. The lean caustic stream 333 from caustic scrubber 330 can be fed into a neutralization scrubber 355 of FIG. 3C, which is similar to neutralization scrubber 150. The lean caustic stream 333, including NaOH and Na₂CO₃, are fed into the neutralization scrubber 350 and react with hydrochloric acid to form NaCl and water along with carbon dioxide. The neutralization scrubber 355 is typically operated from about 20 C to slightly elevated temperature of 60 C. The remaining CO₂ that is produced by the neutralization scrubber 355 can be released via CO₂ outlet 356 to the environment or further processed by compressor 357 and stored in storage tanks 358.

In a further example of the present disclosure, the NaCl and water is transferred from the neutralization scrubber 355 via the neutralization scrubber bottoms 354 to an electrolyzer 360 of FIG. 3C that can create an electrolyte for a power source along with hydrogen gas and chlorine gas for the creation of the hydrochloric acid used in the neutralization scrubber 355.

The electrolyzer 360 receives the NaCl and water from the neutralization scrubber bottoms 354 and undergoes a chloralkali process to form hydrogen gas, chlorine gas and sodium hydroxide. The electorlyzer 360 passes a current through an aqueous solution that includes the NaCl from the neutralization scrubber 355, and electrolysis separates the ions and produces chlorine gas (Cl₂) stream 364 through an oxidation reaction at the anode and hydrogen gas (H₂) stream 366 and sodium hydroxide, through a reduction reaction, at the cathode. The electrolyzer 360 can include a membrane (not shown) to separate the products and facilitate the creation of the products, e.g., sodium hydroxide, hydrogen gas, and chlorine gas.

The hydrogen gas stream 366 of FIG. 3C and the chlorine gas stream 364 can be combined to form hydrochloric acid. The HCl stream 365 formed can be transferred to neutralization scrubber 355 to facilitate the neutralization reaction. The hydrogen gas stream 366 can also be compressed, stored, and sold. Similarly, the HCl, instead of or in addition to being used in neutralization scrubber 355, can be stored and sold.

The sodium hydroxide from the electrolyzer 360 can be fed via rich caustic stream 362 into the caustic scrubber 330 and used to remove the carbon dioxide from the flue gasses. The rich caustic stream 362 can be chlorinated by combining it with the chlorine gas stream 364 from the electrolyzer 360, to additionally create NaOCl, NaCl, and water as byproducts of the reactions. The chlorination reaction will typically be run at low temperatures, e.g., less than 25 C to prevent the hypochlorite product from decomposing. The NaOH can also be fed into an an energy storage system, similar to energy storage system 280, described above with respect to FIG. 2B. The NaOH can also be stored and sold instead of or in addition to recycling it into the caustic scrubber 330.

In a further example of the present disclosure, lean caustic stream 333, prior to being used as a source of sodium carbonate, can, in addition, be used to create NaHCO₃. Sodium bicarbonate can be formed by taking the CO₂ from top stream 324 prior to introducing it into the caustic scrubber 330. The CO₂ from the top stream 324 can be reacted in NaHCO₃ generator 370 of FIG. 3B, with the lean caustic stream 333, to form NaHCO₃. The sodium hydroxide from the lean caustic stream 333 will react with the CO₂ from the top stream 324 to form sodium bicarbonate. Further, the sodium carbonate and water from the lean caustic stream 333 will also react with the carbon dioxide from the top stream 324 to form sodium carbonate.

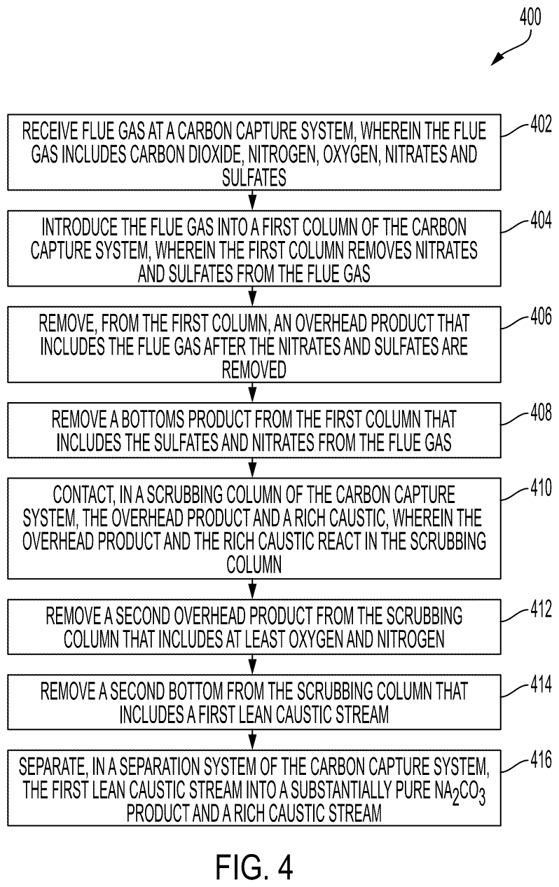

FIG. 4 illustrates an example method for using the carbon capture systems of FIGS. 1, 2A-2B and 3A-3C, where a flue gas is captured from a previous process, purified, and removing the carbon dioxide present. Although the example method depicts a particular sequence of operations, the sequence may be altered without departing from the scope of the present disclosure. For example, some of the operations depicted may be performed in parallel or in a different sequence that does not materially affect the function of the method. Additionally, some of the depicted operations may be optional, and some operations that are not depicted might be part of the method. In other examples, different components of an example device or system that implements the method may perform functions at substantially the same time or in a specific sequence.

In block 402, routine 400 receives flue gas at a carbon capture system, wherein the flue gas includes carbon dioxide, nitrogen, oxygen, nitrates and sulfates. Further, the flue gasses often include further contaminants, for example, sulfates, nitrates, and other contaminates can enter the carbon capture system 200 shown in FIG. 2A or Carbon capture system 300 shown in FIG. 3A. The systems of the current disclosure can remove the contaminants, including CO₂ from the flue gas entering the carbon capture system 200 or 300.

In block 404, routine 400 introduces the flue gas into a first column of the carbon capture system, wherein the first column removes nitrates and sulfates from the flue gas. For example, the first column can be the hydrogen peroxide scrubber 225 as illustrated in FIG. 2A or hydrogen peroxide scrubber 325 illustrated in FIG. 3A. The hydrogen peroxide scrubbers use a stream rich in hydrogen peroxide to react with and absorb the sulfates and nitrates. The resulting solution that exits the bottom of hydrogen peroxide scrubber 225 as illustrated in FIG. 2A or hydrogen peroxide scrubber 325 from FIG. 3A, contains the substantial majority of the sulfates and nitrates present from the flue gas.

In block 406, routine 400 removes, from the first column, an overhead product that includes the flue gas after the nitrates and sulfates are removed. The top stream 224 and/or 324 from FIGS. 2A and 3A, can be further purified to remove any hydrocarbons, sulfur, mercury and particulates, as illustrated in FIGS. 2A and 3A. For example, the hydrocarbons can be removed via hydrocarbon removal column 228 or 328, the sulfur can be removed via sulfur removal column 211 or 311. Mercury can be removed via mercury removal column 212 or 312. Particulates can be removed via particulate filter 213 or 313. The top stream 224 can then be heated and compressed prior to being transferred to the caustic scrubber 230 or 330.

In block 408, routine 400 removes a bottoms product from the first column that includes the sulfates and nitrates from the flue gas. The bottoms from the first column can be further refined to remove both the sulfates and nitrates from solution. Specifically, the sulfates can be removed via the sulfate removal tank 217 or 317 as illustrated in FIGS. 2A and 3A, respectively. The sulfate removal tanks can be treated with calcium oxide or barium oxide, for example, to react with the sulfates, the results of which will precipitate out of solution. The nitrates are typically removed via a separation column, for example, separation column 218 in FIG. 2A and separation column 318 in FIG. 3A, which operate via distillation, ion-exchange, electrodialysis, reverse osmosis, or solvent extraction. The now rich hydrogen peroxide stream can be recycled into the first column in a continuous manner so as to continually remove the impurities, e.g., sulfates and nitrates, from the input stream.

In block 410, routine 400 contacts, in a scrubbing column of the carbon capture system, the overhead product and a rich caustic, wherein the overhead product and the rich caustic react in the scrubbing column. For example, the flue gasses, after being purified as discussed above, can be transferred to caustic scrubber 230 or 330 where the flue gasses are reacted with a caustic solution, for example, sodium hydroxide or potassium hydroxide. The carbon dioxide reacts with the caustic solution and then precipitates out as sodium carbonate. The sodium carbonate and caustic solution are then removed from the bottom of the scrubbing column for removal of the sodium carbonate and recovery of the caustic solution.

In block 412, routine 400 removes a second overhead product from the scrubbing column that includes at least oxygen and nitrogen. For example, the top stream, meeting National Ambient Air Quality Standards (NAAQ), can be released to the environment because it is primarily oxygen and nitrogen and below the NAAQ standards in particulates and other pollutants.

In block 414, routine 400 removes a second bottom from the scrubbing column that includes a first lean caustic stream. The rich caustic stream can be transferred to an energy storage unit to 180 of FIG. 1 or 280 of FIG. 2B. The energy storage unit can be a metal air battery and can have its own electrolyte loop where the rich caustic stream is used to replenish and operate the metal air battery. An energy storage systems 180 or 280 can be placed at any point within the carbon capture system 100, 200, or 300 that has a rich caustic stream, and the energy storage unit can be used to power the operations of the carbon capture system.

In block 416, routine 400 separates, in a separation system of the carbon capture system, the first lean caustic stream into a substantially pure Na₂CO₃ product and a rich caustic stream. For example, the first lean caustic stream can be transferred to filter press 240 or 340 as depicted in FIGS. 2B and 3B. The filter press 240 or 340 can remove the TSS from the solution, leaving a wet cake of Na₂CO₃, that can be transferred to a dryer to remove the moisture and dry the cake of Na₂CO₃. The solution left after the filter press can be further purified by reverse osmosis and/or a crystallizer or centrifuge. After purification, the caustic stream has sufficient NaOH to be considered a rich caustic stream and recycled into the caustic scrubber 230 or 330 of FIGS. 2A and 3A.

According to further examples, the sodium carbonate from the filter press of FIG. 2B or 3B can be broken down into its constituent parts in the neutralization scrubber 355 of FIG. 3B. Then the brine that is formed at the bottoms of neutralization scrubber 355 can be used in an HCl generator, e.g., electrolyzer 360 of FIG. 3C. The HCl from the HCl generator can then be used in the neutralization scrubber 350 of FIG. 3C to generate the brine and CO₂. The output of the HCl generator is a rich caustic stream that can be used to either the electrolyte of a power generation unit, sold as sodium hydroxide, or recycled back to the caustic scrubber to remove CO₂ from the flue gas stream.

What is claimed is:

1. A method for making soda ash from flue gasses comprising:
receiving a flue gas at a carbon capture system, wherein the flue gas includes carbon dioxide, nitrogen, oxygen, and at least one of nitrates, sulfates, fly ash, particulate matter, hydrocarbons, mercury, or sulfur,
introducing the flue gas into a first column of the carbon capture system, wherein the first column removes the nitrates and the sulfates from the flue gas,
removing, from the first column, an overhead product that includes the flue gas after the nitrates and the sulfates are removed;
removing a bottoms product from the first column that includes the sulfates and nitrates from the flue gas;
contacting, in a scrubbing column of the carbon capture system, the overhead product and a rich caustic, wherein the overhead product and the rich caustic react in the scrubbing column;
removing a second overhead product from the scrubbing column that includes at least oxygen and nitrogen;
removing a second bottom from the scrubbing column that includes a lean caustic stream;
separating, in a separation system of the carbon capture system, the lean caustic stream into a substantially pure Na₂CO₃ product and a rich caustic stream.

2. The method of claim 1, wherein the rich caustic is primarily sodium hydroxide.

3. The method of claim 1, further comprising:
contacting the rich caustic stream with a first metal air battery, wherein the rich caustic stream is an electrolyte for the first metal air battery;
generating electricity in the first metal air battery using the additional rich caustic stream as the electrolyte; and
after using the rich caustic stream as the electrolyte in the first metal air battery, adding the rich caustic stream to the scrubbing column.

4. The method of claim 3, wherein the first metal air battery provides the electricity to power the scrubbing column.

5. The method of claim 3, further comprising:
storing the electricity from the first metal air battery.

6. The method of claim 1, further comprising:
purifying, in the separation system, the rich caustic stream and the substantially pure Na₂CO₃ in a first reactor with a catalyst to form carbon dioxide, wherein the separation system includes at least one of a multistage reverse osmosis filter, nanofiltration, centrifuge, and a crystallizer, wherein the Na₂CO₃ is at least 99% purity.

7. The method of claim 6, wherein the Na₂CO₃ has at least a 99% purity.

8. The method of claim 1, further comprising:
prior the separation system, splitting the lean caustic stream into a first lean caustic stream and a second lean caustic stream;
transferring the first lean caustic stream to a crystallizer; and
recycling the second lean caustic stream into the scrubbing column.

9. The method of claim 8, further comprising:
adjusting at least a flow rate of the lean caustic recycle stream, wherein based on the flow rate of the lean caustic recycle stream, the first lean caustic stream is between 4% and 6% Na₂CO₃.

10. The method of claim 1, further comprising:
feeding the rich caustic stream into a second metal air battery, wherein the rich caustic stream is an electrolyte for the second metal air battery;
generating electricity in the second metal air battery using the rich caustic stream as the electrolyte; and
transferring the rich caustic stream from the second metal air battery to the scrubbing column.

11. The method of claim 10, wherein the electricity is used to power at least one of the separation systems and the scrubbing column.

12. The method of claim 10, further comprising:
reacting hydrochloric acid with the substantially pure Na₂CO₃ product in a second reactor; and
collecting, from the second reactor, substantially pure CO₂ from a top of the second reactor and a brine solution from a bottom of the second reactor.

13. The method of claim 12, further comprising:
performing electrolysis on the brine solution to create a chlorine gas stream, a hydrogen gas stream, and a sodium hydroxide stream.

14. The method of claim 13, wherein the sodium hydroxide is recycled into the scrubbing column as a second rich caustic stream.

15. The method of claim 13, further comprising:
performing electrolysis on the hydrogen gas, a carbon dioxide stream, and a first lean caustic stream to form a NaHCO₃ stream, the overhead product, and a second hydrogen gas stream, wherein the overhead product includes carbon dioxide.

16. The method of claim 1, further comprising:
purifying the overhead product via at least one of a demister, a hydrocarbon removal column, a sulfur removal column, a mercury removal column, and a particulate filter.

17. A carbon capture system comprising:
a first scrubbing column, wherein the first scrubbing column removes nitrates and sulfates from an input, wherein an overhead product from the first scrubbing column includes a flue gas after separation and a bottoms product from the first scrubbing column includes the sulfates and nitrates from the flue gas;
a second scrubbing column, wherein the second scrubbing column removes carbon dioxide from the flue gas using a rich caustic, wherein a second overhead product from the second scrubbing column includes oxygen, nitrogen and carbon monoxide and a second bottom from the second scrubbing column includes a first lean caustic stream;
a separation system, wherein the separation system removes a substantially pure Na₂CO₃ product.

18. The carbon capture system of claim 17, further comprising:
at least one of a demister, a hydrocarbon removal column, a sulfur removal column, a mercury removal column, and a particulate filter.

19. The carbon capture system of claim 18, wherein the substantially pure Na₂CO₃ has a purity of at least 99%.

20. The carbon capture system of claim 17, further comprising:
a metal air battery in fluid communication with the rich caustic.
